(19) United States
(12) Patent Application Publication
(10) Pub. No.: US 2020/0273367 A1
(43) Pub. Date: Aug. 27, 2020

(54) Method Of Training The Leaf-Floating

(71) Applicants: Cheolghee Kim, Gyeonggi-do (KR); Chikwon Ahn, Incheon (KR)

(72) Inventors: Cheolghee Kim, Gyeonggi-do (KR); Chikwon Ahn, Incheon (KR)

(21) Appl. No.: 16/285,977

(22) Filed: Feb. 26, 2019

(51) Int. Cl. G09B 19/00; A63B 69/12

(52) U.S. Cl. CPC G09B 19/003; E04H 4/0006; A63B 2208/03; A63B 69/12

(57) ABSTRACT

Present invention provides a Leaf-floating training method comprising following steps: Step 1: preparatory exercise (relaxing muscles); Step 2: dry-land rehearsals (learning the Leaf-floating posture); Step 3: getting familiar with water; Step 4: breathing at the swimming pool edge; Step 5: ‘off-the-edge’ training; Step 6: finding balance between the upper and lower bodies with application of the Archimedes' Law of the Lever; Step 7: straightening knees and whole body; and Step 8: improving the Leaf-floating posture. A trainee should repeat the Steps 4 to 8 until they can stay afloat for more than 1 hour.

### FIELD OF THE INVENTION

This invention relates to the Leaf-floating technique as a new method for surviving in deep waters. More specifically, the present invention allows swimming instructors to train students on the Leaf-floating techniques as an easy and effective drowning prevention method for surviving when one falls into deep waters such as the sea, rivers, lakes, and so on. This Leaf-floating drowning prevention method can be used as a stand-alone method or as a core part of the existing survival swimming methods.

### BACKGROUND OF THE INVENTION

The Leaf-floating, a compound word of “leaf” and “floating”, means floating on the water like a leaf. It is a posture in which the human body gently floats on the water like a leaf, using a special posture and a breathing method specifically designed for it. The Leaf-floating is one of the back-floating methods but it is unique in that it floats the entire body near the surface of the water, keeping the linear and lateral balances of the body. Unlike most other survival swimming methods which require swimming or other body movements in order not to sink, the Leaf-floating method calmly floats the body on the water like a leaf, rendering a highly effective anti-drowning method.

In other conventional floating methods, it is difficult to maintain such perfect body balances for an extended time as the lower body sinks into the water. Once your lower body sinks, it is affected by the resistance and frictions created by waves and whirls. Avoiding drowning under such circumstances requires intense energy consumption. On the other hand, the Leaf-floating helps conserve energy because it reduces the resistance and frictions by keeping perfect balances of the body by having arms, head, chest, and both feet at the water surface level. By maintaining the lateral and linear balances of the body on the water, you will feel very little weight and water resistance and frictions.

### SUMMARY OF THE INVENTION

The Leaf-floating technique ingeniously applies Archimedes' two important findings: ‘Buoyancy’ and ‘Law of the Lever’. After a long period of research, we have discovered that combining those two findings of the Greek mathematician and physicist can make the human body float in the water effectively. This will further be explained in detail in the core technical principles section below.

Once you float, finding the body balances, you can keep the balances for an extended time without significant additional effort. This balanced posture allows you to wait for a rescue force to come to rescue you, by simply lying on the water calmly. Thus, it is proven to be a simple, but highly effective survival method. As the Leaf-floating relies primarily on the natural body buoyancy, it does not require a life vest, which may not be easily available in case of sudden water-related accidents. Unlike the traditional ‘swim-to-survive’ methods, children and adults can learn the Leaf-floating method quite easily within a few hours.

The merit of the Leaf-floating is that it is a suitable technique for the “swimming-disadvantaged groups” such as children, women, and elderly people who are physically weaker and have less developed physique than young males. Surprisingly, those groups can learn the Leaf-floating much more easily as their bones are relatively lighter. Normally, children of 6 to 7 years old can control their breathing for the Leaf-floating, and seniors as old as 90 years can learn the Leaf-floating without any difficulties.

Also, compared to the other conventional swimming methods, this simple Leaf-floating method can be learned quite easily. The Leaf-floating is particularly advantageous for children who have not learned how to swim, as it does not require swimming motions. Normally, a child can learn how to float within one hour or two, if not in a few minutes. It is one of the core merits that you can learn it regardless of your swimming skills.

Before you practice the Leaf-floating, it is advisable to observe the following basic tips.

First, get into the water wearing your shoes and clothes. In usual cases, when you fall into the water, one of the most unbearable things is hypothermia from cold water. Therefore, getting into the water wearing clothes can help preserve warmth and protect body temperature. Also, most shoes provide buoyancy effect to some extent, which is very advantageous for the Leaf-floating in which both feet should be floating on the water.

Second, take a deep breath to secure sufficient buoyancy. Before you get into the water make sure that you inhale deeply and maintain 80 to 90 percent of the air in your lungs all the time, exchanging only 10 to 20 percent with quick breaths. This unique breathing method along with abdominal breathing method will provide enough buoyancy to keep your body afloat.

Third, execute the precise motions and posture required for the Leaf-floating in order to lift your heavy lower body up to the surface. Lifting your heavy lower body (legs and feet) is not easy for it is far away from the lungs and cannot be supported by buoyancy provided by them. Utilizing Archimedes' Law of the Lever will help your heavy lower body to float. We will explain it in detail in the “Technical Principles of the Leaf-floating” section below.

Fourth, once the Leaf-floating balance is achieved, concentrate on maintaining the balance and not moving the body or limbs. Once the Leaf-floating posture has been completed, you must quietly stop the motion, and concentrate on keeping the linear and lateral balances. Otherwise, your body balances will be broken. The Leaf-floating buoyancy is provided by the water, not by your physical strengths. Thus, it is a clear advantage that even children can wait for the rescue force for a long time without wasting energy.

One inconvenient point while learning the Leaf-floating is that water enters the nose and irritates it. But, you can overcome it by practicing how to spit out of mouth when the water enters the nose.

Core Technical Principles of the Leaf-Floating

The core technical principles of the Leaf-floating are based on Archimedes' two important findings, ‘Buoyancy’ and ‘Law of the Lever’, which are the essence of this invention. It is our new finding that combining those two principles can float one's whole body in the water, making it an effective anti-drowning method.

Most people have positive buoyancy when they take a deep breath. When you have a full breath in the water, part of your body (face, chest) tends to float above the surface, which is called ‘positive buoyancy’. However, unlike your upper body supported by the buoyancy provided by lungs, the heavy lower body tends to sink because it is more developed in terms of physique and is therefore heavier. Therefore, you need to apply another finding of Archimedes (Law of the Lever) to lift the lower body up and keep it at the same level as the upper body. In order to lift the heavy lower body you need to provide an additional effort by making the upper body longer and, on the other hand, reducing the load by making the lower body length shorter.

You may easily understand this if you imagine that your body is a seesaw. Imagine a seesaw with the fulcrum in the middle. You need to adjust the body length on each side until you find the exact balance. Most people cannot float in a stable manner before they learn the Leaf-floating method.

It is essential to move the center of gravity utilizing Archimedes' Law of the Lever to raise the heavy lower body to the water surface while keeping the amount of the positive buoyancy the same. Most individuals that have tested the Leaf-floating method have found it to be effective.

Thus, this invention, based on the above theory, provides easy, effective, and systematic education and training methods so that anyone can learn the Leaf-floating technique, regardless of their swimming capabilities.

The main object of present invention is to provide a new method for preventing drowning by waiting for the rescue force when one falls into deep waters, referred to herein as the Leaf-floating method.

Another object of the invention is to provide for the instructors to obtain the necessary knowledge to train students on the Leaf-floating method.

Another object of the invention is to provide new Leaf-floating method that can be learned regardless of swimming capabilities and allows for floating on the water for a long time without using much energy.

The above and some other objects can be achieved by the invention described in detail below.

The Leaf-floating training method typically follows the following steps: Step 1: preparatory exercise (relaxing muscles); Step 2: dry-land rehearsals (learning the Leaf-floating posture); Step 3: getting familiar with water; Step 4: breathing at the edge of the swimming pool (breathing and buoyancy training); Step 5: off-the-edge Leaf-floating training; Step 6: finding balance between the upper and lower bodies (using the Archimedes' Law of the Lever); Step 7: straightening knees and whole body; Step 8: improving the Leaf-floating. It is necessary to practice the Steps 4 to 8 by repeating them to stay afloat for 1 hour or so.

Step 1: preparatory exercise (relaxing muscles). The goal is to make the neck and whole body muscles relaxed. This preparatory exercise will take 3 minutes to 5 minutes under the guidance of the instructor.

Step 2: dry-land rehearsals (learning the Leaf-floating posture). The dry-land rehearsals are for getting familiar with the typical Leaf-floating posture. The student (trainee), while standing with feet slightly apart, holds both hands up keeping the hips behind and knees slightly bent. The typical Leaf-floating posture is leaning forward, not backward, it should be as if you are going to embrace your friend (see FIG. 1). Retain this posture for about 5 minutes under the guidance of the instructor.

Step 3: getting familiar with water. Step 3 is to help the beginners get familiar with the water. The students are instructed to hold their breath for as long as they can by submerging their face under the water which is about waist-deep. Practice this for about 5 minutes under the guidance of the instructor.

Step 4: breathing at the edge of the swimming pool (breathing and buoyancy training). Step 4 is for getting used to the Leaf-floating breathing while the trainees have their heels placed on the edge of the swimming pool (see FIG. 2). Take a deep breath and exhale only 10 to 20 percent of your full breath to increase buoyancy by keeping the rest of the air in your lungs. You may keep your arms either crossed over the chest or in an upheld position. Try this step 10 to 15 times for about 20 minutes with the help of the instructor or your buddy (a paired classmate). Once you can breathe comfortably in this position without any assistance, you can move on the next step.

Step 5: ‘off-the-edge’ Leaf-floating training. Step 5 has trainees remove their feet from the edge of the pool, teaching trainees to get used to floating in the Leaf-floating position without the support of the pool's edge. Try this step 10 to 15 times for about 20 minutes with the help of the instructor or your buddy.

Step 6: making a balance between the upper and lower bodies (applying the Archimedes' Law of the Lever). Step 6 is a step for lifting your heavy lower body and keeping it at the same level as the upper body. When you make your upper body longer (by stretching arms and armpits) while making the lower body shorter (by bending your knees), the center of gravity is moved toward upper body and your body is tilted back and the legs are lifted. Focus on keeping the tip of knees at the surface level once you succeeded in lifting the lower body. Practice this step 10 to 15 times for about 20 minutes.

Step 7: straightening knees and whole body. When you are comfortable with keeping your knees at the surface level with stability, then you can slowly straighten your knees and stretch whole body to improve the Leaf-floating posture. After practicing this step for about 20 minutes, you will be able to make your body float for more than 1 minute.

Step 8: improving the Leaf-floating posture. The goal of step 8 is to gradually improve the Leaf-floating posture and to increase time of floating. You can do this by fully relaxing your whole body and avoiding unnecessary energy exertion. Practice until you can stay afloat for 5 to 10 minutes at a time.

Step 9: extending the Leaf-floating duration. If you can float on water for more than 5 minutes by following above steps appropriately, keep practicing to stay afloat with stability for more than 10 minutes, 30 minutes, or 1 hour.

Step 10: training under real situations. This final step can be done by creating artificial waves or stirs in the swimming pool. After that, the training can be done in relatively calm rivers and seas, then eventually move to rapid rivers or rough seas to get used to much more severe situations.

As those skilled in the art will appreciate, the present invention is not limited to the method steps and description articulated above. Other objects of the present invention and its particular advantages will become more apparent from consideration of the following drawings and detailed description of the invention.

### BRIEF DESCRIPTION OF THE DRAWINGS

FIG. 1 is an illustration of the second stage of the Leaf-floating training method according to an exemplary institution of the present invention. It depicts a typical posture for the Leaf-floating technique with the trainee in a standing position.

FIG. 2 is an illustration of a student learning proper breathing for the Leaf-floating while keeping the heels on the edge of the swimming pool according to the exemplary institution of the present invention depicted in FIG. 1.

FIG. 3 is an illustration of the sixth step of the Leaf-floating training to make the upper and lower bodies balanced utilizing the Archimedes' Law of the Lever according to the exemplary institution of the present invention depicted in FIGS. 1-2.

FIG. 4 is an illustration of the posture for the complete Leaf-floating technique according to the exemplary institution of the present invention depicted in FIGS. 1-3. Here, the knees and the whole body are straightened and stretched, maintaining the balance between the upper and lower bodies.

### DETAILED DESCRIPTION OF THE INVENTION

Present invention provides a method suitable for teaching the Leaf-floating to help the trainee to survive in case they fall into deep seas, rivers, or lakes without wearing a life vest. The following detailed description illustrates the invention by way of example, not by way of limitation of the principles of the invention. This description will enable one skilled in the art to use the invention and describes several embodiments, adaptations, variations, alternatives and uses of the invention, including what is presently believed to be the best mode of carrying out the invention. One skilled in the art will recognize alternative variations and arrangements, and the present invention is not limited to the implementations described hereafter.

The present invention relates to the Leaf-floating training method, which comprises the following 10 steps. Step 1: preparatory exercise (relaxing muscles); Step 2: dry-land rehearsals (learning the Leaf-floating posture); Step 3: getting familiar with water; Step 4: breathing at the swimming pool edge (breathing and buoyancy training); Step 5: off-the-edge Leaf-floating training; Step 6: finding balance between the upper and lower bodies (applying the Archimedes' Law of the Lever); Step 7: straightening knees and whole body; and Step 8: improving the Leaf-floating position. Train in order to stay afloat for at least 1 hour by repeating Steps 4 to 8. The following is detailed training method.

Step 1: Preparatory Exercise (Relaxing Muscles)

This first step of learning the Leaf-floating is to make the neck and whole body muscles relaxed. Relaxation of the neck muscles is especially crucial as it affects the muscles of the entire body. Relaxed muscles help the body to float on water much more easily, saving energy while floating. To relax the neck muscles, first, push your head down from the back of your head using both hands, and then from right to left using your left hand, and then from left to right using your right hand. Finally, push your head up from under your chin using your both thumbs. Each time you hold for about 10 seconds before relaxing again.

To relax the muscles of whole body, stand up fully, relaxed, with legs apart at shoulder width and make small but quick up and down vibration movements using mainly the muscles in the bottom of your feet. Do it as if you are trying to remove water from your fingertips. This preparatory exercise will preferably take 3 to 5 minutes under the guidance of the instructor.

Step 2: Dry-Land Rehearsals (Learning Leaf-Floating Posture)

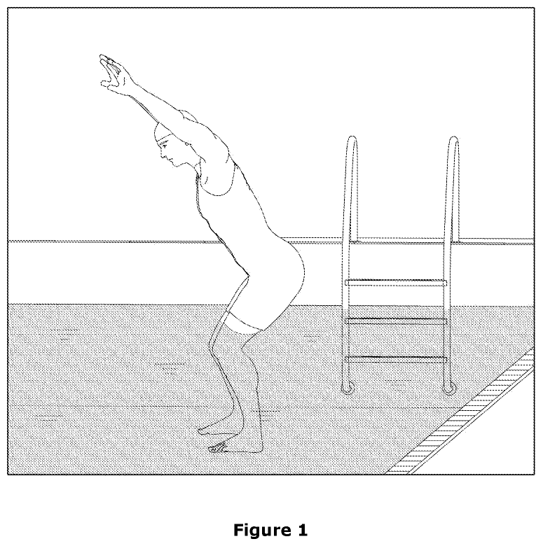

The second step is getting familiar with the typical Leaf-floating posture. The Leaf-floating technique uses a posture that helps the feet to float, using a ‘feet-friendly’ posture. On the water, the posture of arms stretched upward, hips pushed backward, and knees slightly bent is maintained while lying on the water; and in the dry-land rehearsal, the trainee repeats this posture while standing on their feet. That is, the trainee keeps the hands up and stretched out while standing up, leaning forward while the hips are pushed backward and the knees are slightly bent, and this movement is repeated (see FIG. 1).

FIG. 1 is an illustration of a posture of the second step of the Leaf-floating training. By repeating this posture in the standing position, the correct posture on the water can be learned beforehand out of the water. This step is preferably carried out for about 5 minutes under the guidance of the instructor.

Step 3: Getting Familiar with Water

This step is training carried out in water repeatedly until the trainee can hold their breath as long as possible by submerging their face under waist or breast-deep water. Submergence time may be short initially but duration of submergence will extend gradually. This step is for the non-swimmers to get familiar with the water and therefore eliminating fear of water. Duration of submergence can be adapted accordingly to individuals' capabilities. This step is preferably practiced for about 5 minutes under the guidance of the instructor.

Step 4: Breathing at Swimming Pool Edge Breathing and Buoyancy Training)

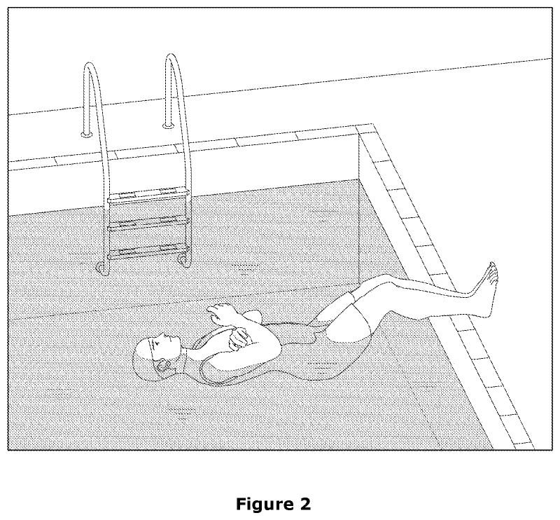

Step 4 is for getting used to the Leaf-floating breathing and buoyancy while heels of the trainee are placed on the edge of the swimming pool (see FIG. 2).

FIG. 2 is an illustration of the posture for breathing exercise for the Leaf-floating at the edge of the swimming pool. As the trainee cannot float at this stage, in this step they should primarily focus on breathing and securing sufficient buoyancy by keeping part of the face and chest floating above the surface level while having their heels placed on the edge of the pool and maintaining lying position on water. In this position, the trainee should keep the face (nose and mouth) from submerging. It is advisable to pair up trainees so that they can help each other alternately. In this step a buddy (a paired classmate) can help the trainee by supporting their back. The support allows the trainee to lie on the water comfortably.

Nearly everyone can maintain floating on the water by themselves with their feet placed on the edge of the pool after repeating this step 10 to 15 times. During this step, arms can be crossed or stretched upward. Submerging outstretched arms helps floating the body with that much buoyancy. Take a deep breath and exhale only 10 to 20 percent of your full breath to increase buoyancy by keeping the rest of the air in your lungs. In other words, exhale only a small amount of air while keeping most of your breath in your lungs to increase buoyancy. Always exchange only 10 to 20 percent with quick breaths and maintain rapid inhale and exhale such that 80 to 90 percent of the air is in your lungs all the time. This breathing method must be maintained to secure the buoyancy effect throughout the training course. Lungs kept inflated by the Leaf-floating breathing technique provide significant buoyancy to the body such that the trainee's face will not be submerged under water.

After practicing this step preferably 10 to 15 times for about 20 minutes with the help of the instructor or your buddy (a paired classmate), you can comfortably float on water by yourself with your feet placed on the edge. In order to float comfortably on the water, you can tilt your head backwards slightly. When you have mastered the Leaf-floating, you don't have to tilt your head backwards, and can even pull your chin forward. If you can breathe comfortably without any help, you can move on to the next step.

Step 5: ‘Off-the-Edge’ Leaf-Floating Training

This ‘off-the-edge’ Leaf-floating training step is a process of escaping from the edge. It is advisable to pair up trainees so that they can help each other alternately for this step as well. First, ask for the help of the instructor or the buddy (a paired classmate). Your buddy or instructor can either pull your body or push your feet from the edge while supporting your back and slowly make your body float away from the edge. If you maintain the breathing method you have already learned, your body will stay afloat naturally due to buoyancy. When you hold your hands up and above your head, you have a better chance to float longer. When you can float by yourself, your buddy or instructor can stop supporting you and take their hands away.

After practicing this step preferably 10 to 15 times for about 20 minutes, you can achieve about 1 minute of Leaf-floating by yourself.

After practicing the Steps 1 to 5, about 1 minute of Leaf-floating can typically be achieved without any help. However, in a short while, your lower body, namely your legs begin to sink faster than your upper body, namely your head does. To prevent your legs from sinking, you have to learn the next step.

Step 6: Finding Balance Between Upper and Lower Bodies (Applying Archimedes' Law of the Lever)

In response to the lower body sinking faster than the upper body, namely the head, this step is for learning to keep both the lower body and upper body afloat. While your face and chest are well supported by your lungs, your legs and feet are not supported because they are too far from the lungs and made of heavy bones and muscles.

However, after a long period of research, we have discovered that applying buoyancy and the Law of the Lever to the Leaf-floating works for most people to stay fully afloat. Your body has a fulcrum or pivot point somewhere in your lower back, and by trying to make your upper body longer (by stretching armpits and arms) and making your lower body shorter (by bending legs), your positive buoyancy remains unchanged and your legs and feet will be lifted to the surface level as your body's center of gravity shifts. The further the arms are outstretched above the dead, the easier it is to make the lower body float properly.

If this posture is maintained, the lower body will rise to surface of water (with shift of center of gravity) and float along with the upper body. When your body is kept horizontal on the surface of water with your knees and feet, you can float without feeling weight on any part of your body.

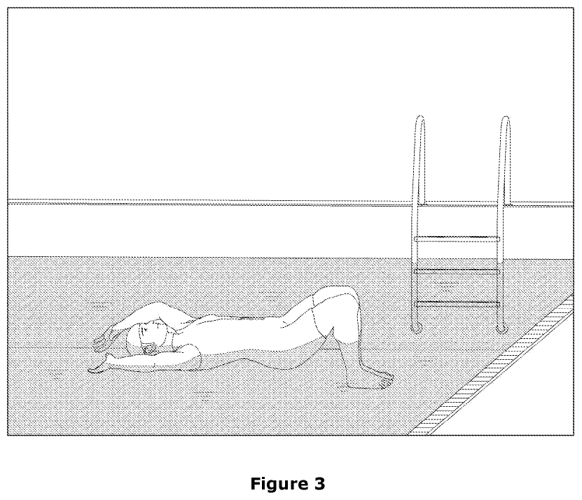

FIG. 3 is an illustration of the posture for the sixth step of the Leaf-floating training to make the upper and lower bodies balanced. Once you have grasped the application of force on your body due to the Law of the Lever, you can float without wasting energy. Until you are completely accustomed to this posture, you should focus mainly on keeping the tip of knees at the surface level. It is preferable to practice this step 10 to 15 times for about 20 minutes with the help of your instructor or buddy, or by yourself. Move on to making your body completely horizontal by straightening your knees once you can remain afloat with application of the Law of the Lever by bending your knees.

Step 7: Straightening Knees and Whole Body

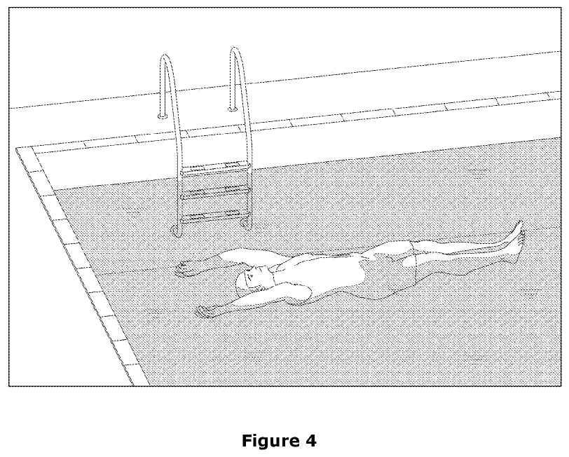

When you can keep on floating with the tip of your knees above the water surface comfortably, you can straighten your knees very slowly while stretching your armpits to the maximum (try not to engage your shoulder muscles in this process) and extending your upper body length by a few more inches while taking a deep breath to add buoyancy. The Leaf-floating posture is complete when you can maintain balance between your upper and lower bodies with your understanding of the Law of the Lever, and can maintain maximum buoyancy by following the breathing method according to the present invention (see FIG. 4).

FIG. 4 is an illustration of the posture for the complete Leaf-floating in which the knees and the whole body are straightened. By repeating this step, taking a deep breath and exhaling only about 10 to 20 percent of your full breath will gradually become less difficult and more comfortable. After practicing this step preferably for about 20 minutes, you can achieve more than 1 minute of perfect Leaf-floating.

Step 8: Improving Leaf-Floating Posture

This step is to further improve the Leaf-floating posture and extend the time of floating gradually. For this step, your whole body should be completely relaxed so that there is no tension in any part of the body. When there is any tension in the body, energy is exerted. By fully relaxing your whole body and avoiding unnecessary energy consumption, the duration of floating can be extended. Practice preferably until you are able to stay afloat for about 5 to 10 minutes at a time. By practicing, you can achieve over 1 hour of Leaf-floating without difficulty.

Step 9: Extending Leaf-Floating Duration

Once the duration of Leaf-floating is longer than 5 minutes, you can stay afloat with stability for more than 10 minutes, 30 minutes, or 1 hour, through repetition. In real life situations, you will be able to stay afloat comfortably without exerting energy, until a rescue team can arrive within any so-called golden time for rescue.

Step 10: Training for Real Situations

In reality, however, we have more accidents in rivers, seas, and lakes, where water is not as calm as that of the swimming pool. Rivers can have rapid streams and seas can have waves. To prepare for real circumstances, this final step of training is necessary and can be done by creating artificial waves in the swimming pool. When you become accustomed to this phase of training, the training can move on to be done in relatively calm rivers and seas. Eventually, move on to rapid rivers or rough seas to simulate tougher situations for real situation training.

While described with reference to particular steps, features, and the like, the present invention is not limited to the above description. Persons with ordinary skills in the field of invention recognize that simple modifications and alterations can be made to the present invention, and that all of such modifications and alterations are considered to be encompassed by the scope of the present invention.

What is claimed is:

1. A method for training Leaf-floating, comprising the following steps:
a preparatory exercise step for relaxing the trainee's neck and body muscles carried out for about 3 to 5 minutes under the guidance of an instructor;
a dry-land rehearsal step for learning the Leaf-floating posture in which the trainee stands with their feet slightly set apart, holds both hands up, pushes their hips behind, bends their knees slightly, and holds this position, wherein the trainee repeats this position for about 5 minutes under the guidance of the instructor to become familiar with this posture for floating on water;
a familiarizing with water step in which the trainee holds their breath as long as possible by submerging their face under waist-deep water, carried out for about 5 minutes under the guidance of the instructor;
an ‘edge-breathing’ step for breathing while lying on the surface of water with the trainee's heels placed on the edge of the swimming pool, wherein the trainee takes a deep breath but exhales only 10 to 20 percent of a full breath in order to retain air in lungs to increase buoyancy, and is carried out 10 to 15 times for about 20 minutes with the help of the instructor or a training buddy;
an ‘off-the-edge’ step in which the trainee moves away from the edge of the swimming pool using their feet previously placed on the edge to push against the edge, and is carried out 10 to 15 times for about 20 minutes with the help of the instructor or the training buddy;
an upper and lower bodies balancing step for floating the trainee's lower body through application of Archimedes' Law of the Lever, in which the center of gravity is moved toward upper body by bending the knees, and is carried out 10 to 15 times for about 20 minutes without any help from the instructor or the training buddy; and
a straightening knees and body step in which the trainee, when they can comfortably float with the tips of their knees above surface of water, stretches armpits and arms above their head to extend their upper body as much as possible while straightening their knees very slowly, and is carried out for about 20 minutes.

2. The method according to claim 1, further comprising an improving Leaf-floating posture step to be carried out after the straightening knees and body step in order to gradually extend the floating duration, wherein the trainee practices until they are able to stay afloat for about 5 to 10 minutes at a time with their body completely relaxed.

3. The method according to claim 2, further comprising a training step with artificial waves created in the swimming pool, and a real situations training step for training in harsh conditions, starting with simulating relatively calm rivers and seas and eventually moving on to rapid rivers or rough seas, to be carried out after the improving Leaf-floating posture step.
